(19) United States
(12) Patent Application Publication
(10) Pub. No.: US 2025/0145405 A1
(43) Pub. Date: May 8, 2025

(54) DUAL WIRE ROPE MOTOR REEL

(71) Applicant: Hubbell Incorporated, Shelton, CT (US)

(72) Inventors: Scott Roger KLAWITTER, Beaver Dam, WI (US); Brett Anthony KNUTSON, West Bend, WI (US)

(21) Appl. No.: 19/016,914

(22) Filed: Jan. 10, 2025

Related U.S. Application Data
(63) Continuation-in-part of application No. 18/339,311, filed on Jun. 22, 2023.
(60) Provisional application No. 63/358,503, filed on Jul. 5, 2022.

(51) Int. Cl. B65H 75/36; B60L 53/18; B65H 75/44; B65H 75/48; F16L 3/12; H02G 11/02

(52) U.S. Cl. CPC B65H 75/36; B65H 75/4428; B65H 75/4486; B65H 75/486; F16L 3/12; H02G 11/02; B60L 53/18; B65H 2405/50; B65H 2701/34

(57) ABSTRACT

A reeling device including a housing, a retraction mechanism, a shaft rotatable by the retraction mechanism, a first drum coupled to the shaft, and a second drum coupled to the shaft, wherein the second drum has an inner diameter greater than an inner diameter the first drum. A first wire rope is attached around the first drum and secured to a first position on an electrical cable with a saddle clamp. A second wire rope is attached around the second drum and secured to a first position on an electrical cable with a saddle clamp, the second position being distal to the first position.

### FIELD OF THE INVENTION

The present disclosure relates to reeling devices, and more particularly, to dual wire reeling device for use with electric vehicle charging stations and other applications.

### BACKGROUND

Fleets of electric vehicles (EV) require means of charging them as-needed, which requires individual stations located within a parking structure capable of distributing electricity to many vehicles simultaneously. The electric cables and charging plugs must be managed to prevent damage to themselves and the vehicles they service.

One means to distribute the electrical energy to dozens of individual charging stations is cable runs underground which terminate at surface mounted access points similar to petroleum gas pumps, but designed to dispense high-current, high-voltage electricity. However, this is not conducive for servicing the cables plus each charging station must be protected from accidental impact due to all the vehicular traffic.

Another means to distribute the electrical energy could be to position the charging station and cable above the vehicles for safety and more economical point of service. For example, the electric cable and plug may be stored in an elevated position. However, this leads to difficulties in ensuring that the cable is easily accessible while also sufficiently elevated to be out of the way of vehicles and pedestrians.

A traditional cable reel could be used to spool the electrical cable above and lower it so the operator can plug in to the vehicle for charging. However, because of the massive heat produced by the energy required to charge an electric vehicle, spooling such an electrical cable could lead to overheating and at a minimum may reduce the longevity of the cable assembly.

There is a need for improved means for electrical cable management for electric vehicles and other applications. The present invention solves these and other problems in the prior art.

### SUMMARY

An object of the present invention is to provide an improved reeling device for various applications such as lowering and raising overhead electrical cables. Another object of the present invention is to provide a means for lowering and raising cables for electrical vehicle charging using such a reeling device. However, reeling devices may be used in various applications to reel and unreel ropes and wires, thus the invention is not limited to a particular application.

In one exemplary embodiment, a reeling device is provided including a housing, a retraction mechanism, a shaft driven by the retraction mechanism, a first drum coupled to the shaft, and a second drum coupled to the shaft, wherein the second drum has an inner diameter greater than an inner diameter of the first drum (e.g., a 2:1 ratio). A first wire rope is attached around the first drum and a second wire rope is attached around the second drum. The first wire rope may be secured to a first position on an electrical cable. The second wire rope may be secured to a second position on the electrical cable, the second position being distal to the first position. In some embodiments, the second position is spaced apart from the first position along a length of the electrical cable by at least five (5) feet.

Each of the first wire rope and the second wire rope may have a saddle clamp attached at a distal end, the saddle clamp including a first housing part secured to a second housing part, a channel defined between the first housing part and the second housing part, and at least one insert removably positioned in the channel having an inner diameter sized to accommodate an electrical cable.

The reeling device is configured to unreel (and reel) the first and second wire ropes, such that the first and second positions of the electrical cable are at a same or similar elevation in a reeled configuration and the second position of the electrical cable is below the first position in an unreeled position. Thus, a distal portion of the electrical cable is below a proximal portion of the electrical cable when the electrical cable is in use.

In some embodiments, the retraction mechanism is a motor and the reeling device further comprises a gear reducer between the motor and a proximal end the shaft. The reeling device may further include a rotary limit switch on a distal end of the shaft.

In some embodiments, the housing includes a base plate and first and second end plates attached to the base plate. The first and second drums are positioned between the first and second end plates. A wire guide assembly may be attached between the first and second end plates including an opening to receive a first wire rope from the first drum and an opening to receive a second wire rope from the second drum. In some embodiments, the wire guide assembly includes a plurality of rollers. In some embodiments, the reeling device has a canopy attached to the base plate including a plurality of walls at least partially circumscribing the reeling device.

The retraction mechanism may be a spring reel including a spring mounted about the shaft. In some embodiments, a locking mechanism is configured to selectively lock rotation of the first and second drums. The locking mechanism may include a gear attached to the shaft and a pawl configured to engage with the gear.

In one exemplary embodiment, a reeling device is configured to lift a free-hanging charging cable assembly toward the ceiling in order to keep a garage area clear for truck and bus traffic. This advantageously eliminates the possibility of the cable assembly being damaged when a driver is parking the vehicle and plugging it in for charging.

A significant advantage for this means of lifting and storing a hanging electric charging cable is the absence of a collector (a.k.a. slip ring) required on a traditional cable reel for storing the cable on a rotating spool. The expense and maintenance associated with a high-voltage, high-current slip ring are eliminated, as are the heat-rise in hot ambient temperatures and potential condensation problems in cold ambient temperatures.

In one exemplary embodiment, an electric vehicle charging assembly is provided including a reeling device including a housing, a retraction mechanism, a shaft rotatable by the retraction mechanism, a first drum coupled to the shaft, and a second drum coupled to the shaft, wherein the second drum has an inner diameter (D2) greater than an inner diameter (D1) the first drum. The assembly includes an electric vehicle charging cable having a proximal end configured to attach to a power source and a distal end configured to attach to an electric vehicle. A first wire rope is wound around the first drum with a distal end attached to a first position on the electric vehicle charging cable with a saddle clamp. A second wire rope is wound around the second drum with a distal end attached to a second position on the electric vehicle charging cable, with a saddle clamp, spaced apart from the first position. The reeling device is operable between a reeled configuration in which the first and second positions of the electrical cable are at an approximately same elevation and an unreeled configuration in which the second position of the electrical cable is below the first position.

Further provided is a saddle clamp for a cable including a first housing part having a first upper portion with a first curved inner surface, a second housing part having a first upper portion with a second curved inner surface, the first housing part and the second housing part being removably attachable, wherein the first curved inner surface and the second curved inner surface define a channel through the saddle clamp, and at least one insert removably securable in the channel, the at least one insert having a first insert part received in the first curved inner surface of the first housing part and a second insert part received in the second curved inner surface of the second housing part.

In some embodiments, the first housing part of the saddle clamp has a first lower portion with an opening and the second housing part of the saddle clamp has a second lower portion with an opening, the respective openings defining a handle of the saddle clamp.

In some embodiments, each of the first insert part and the second insert part of the at least one insert has at least one radially extending tab, the at least one radially extending tab engaging in the first housing part or the second housing part. Each of the first housing part and the second housing part may include a plurality of cavities adjacent to the first curved inner surface and the second curved inner surface, respectively, for receiving the tabs.

The at least one insert may include a plurality of inserts interchangeable positionable in the channel, each having a different inner diameter to accommodate a different cable size.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is an isometric view of a reeling device according to an exemplary embodiment of the present disclosure;

FIG. 2 is a top view of the reeling device shown in FIG. 1;

FIG. 3 is a side view of the reeling device shown in FIG. 1;

FIG. 4 is a front view of the reeling device shown in FIG. 1;

FIG. 5 is a front view of first and second drums of the reeling device shown in FIG. 1;

FIG. 6 is an exploded view of the reeling device shown in FIG. 1;

FIGS. 7A-7B illustrate a reeling device according to an exemplary embodiment of the present disclosure in a ceiling mounted configuration;

FIG. 8 illustrates a reeling device according to an exemplary embodiment of the present disclosure in a wall mounted configuration;

FIG. 9A is an isometric view of a reeling device according to an exemplary embodiment of the present disclosure;

FIG. 9B is isometric view of the reeling device shown in FIG. 9A with a cover removed;

FIG. 10 is a front view of the reeling device shown in FIG. 9A;

FIG. 11 is a side view of the reeling device shown in FIG. 9A;

FIG. 12 is an exploded view of the reeling device shown in FIG. 9A;

FIG. 13 shows a reeling device according to an exemplary embodiment of the present disclosure in a reeled configuration;

FIG. 14 shows the reeling device of FIG. 13 in a first partially unreeled configuration;

FIG. 15 shows the reeling device of FIG. 13 in a second partially unreeled configuration;

FIG. 16 shows the reeling device of FIG. 13 in an unreeled configuration.

FIG. 17 is another isometric view of the reeling device of FIG. 9A having a wire guide with rollers and a pre-tensioning assembly;

FIG. 18 is an isometric view of a saddle clamp according to an exemplary embodiment of the present disclosure;

FIGS. 19A-19D are front, top, bottom, and side views, respectively, of the saddle clamp shown in FIG. 18;

FIG. 20 is an exploded view of the saddle clamp shown in FIG. 18; and

FIG. 21 is an exploded view of a portion of the saddle clamp shown in FIG. 18; and

FIGS. 22A-22E are isometric views of inserts of the saddle clamp shown in FIG. 18.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions, or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure.

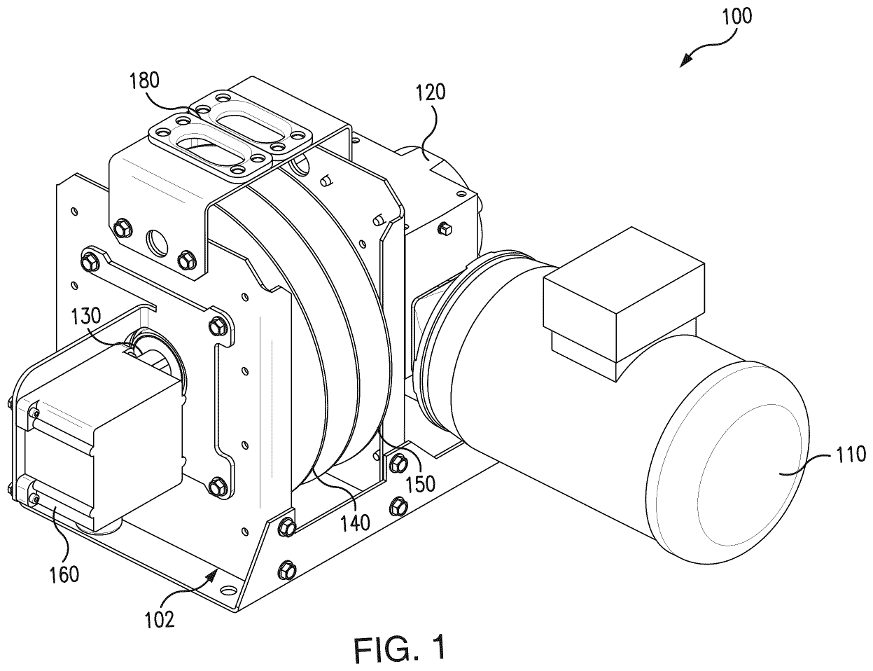

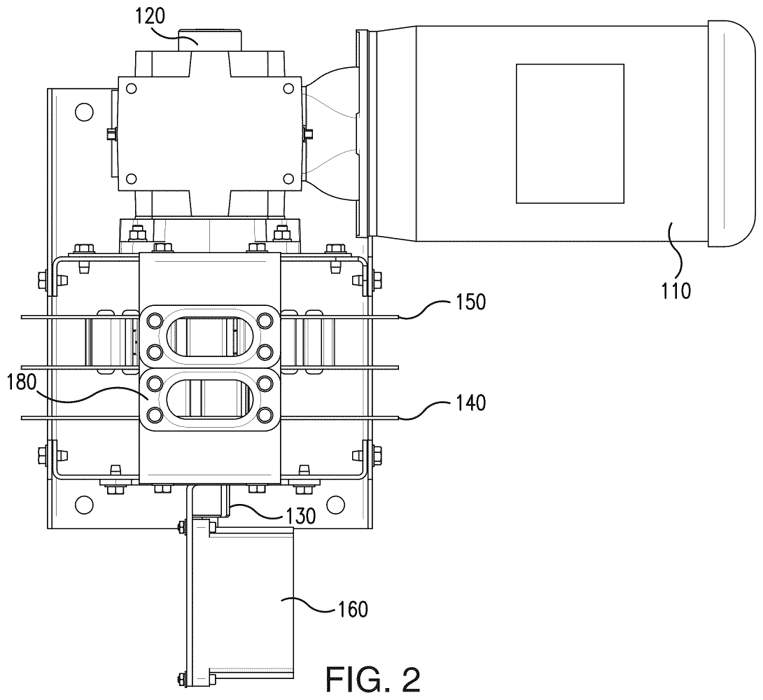

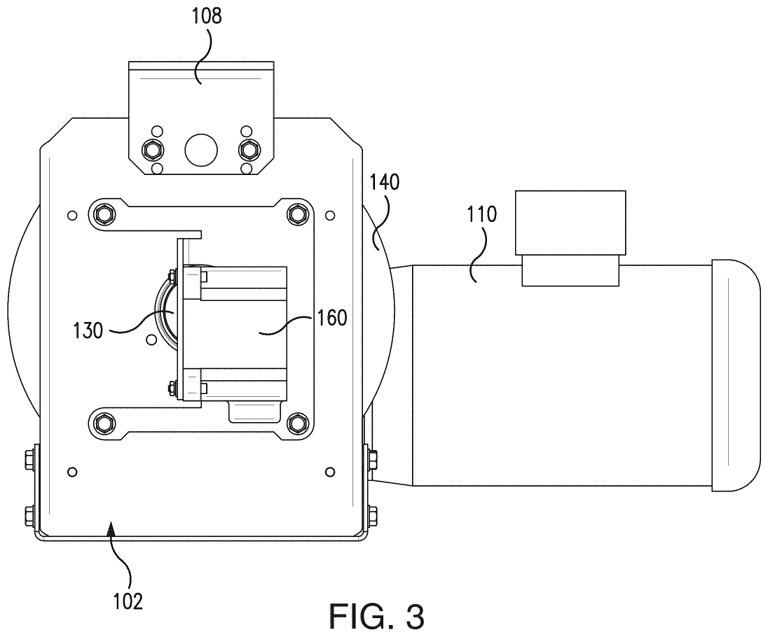

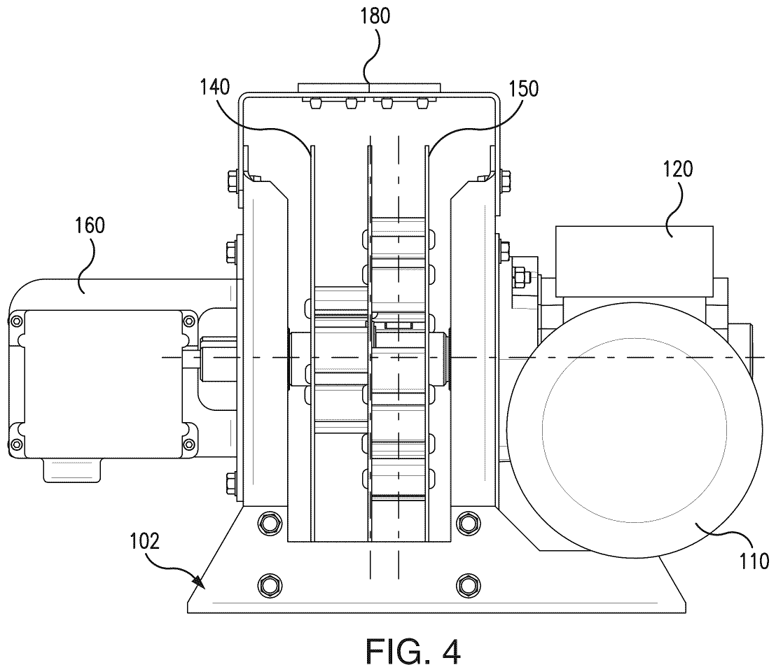

FIGS. 1-4 show a reeling device 100 according to an exemplary embodiment of the present disclosure. The reeling device 100 may be configured for various uses including but not limited to as an overhead retractable reel for use in an electric vehicle charging station. The reeling device 100 provides for the easy extension and retraction of an electric vehicle charging cable. The charging cable can be safely stored out of harm's way when not in use without spooling the electric cable, which can lead to overheating and reduce the longevity of the cable assembly.

The reeling device 100 includes a housing 102 (or frame) and a retraction device in the form of a motor 110, such as an electric motor, secured to the housing 102. In the exemplary embodiment, the motor is a 0.33 horsepower vector duty electric motor. The motor 110 is connected to a gear reducer 120 for driving a shaft 130. In the exemplary embodiment, the gear reducer 120 is a 90-degree worm gear reducer with a 60:1 reduction ratio.

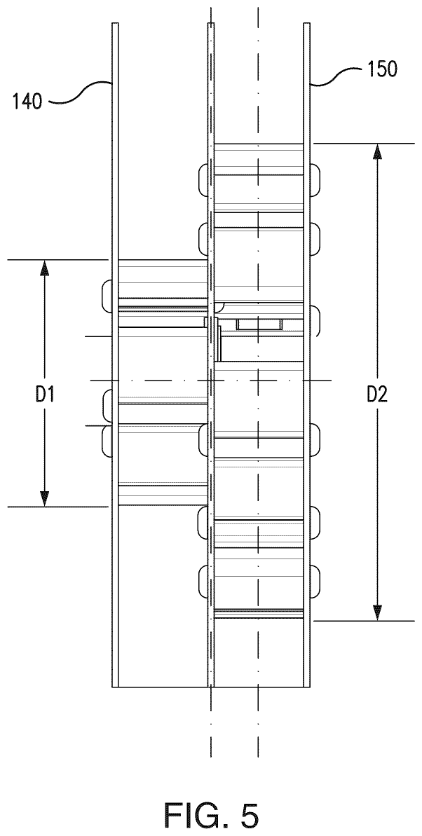

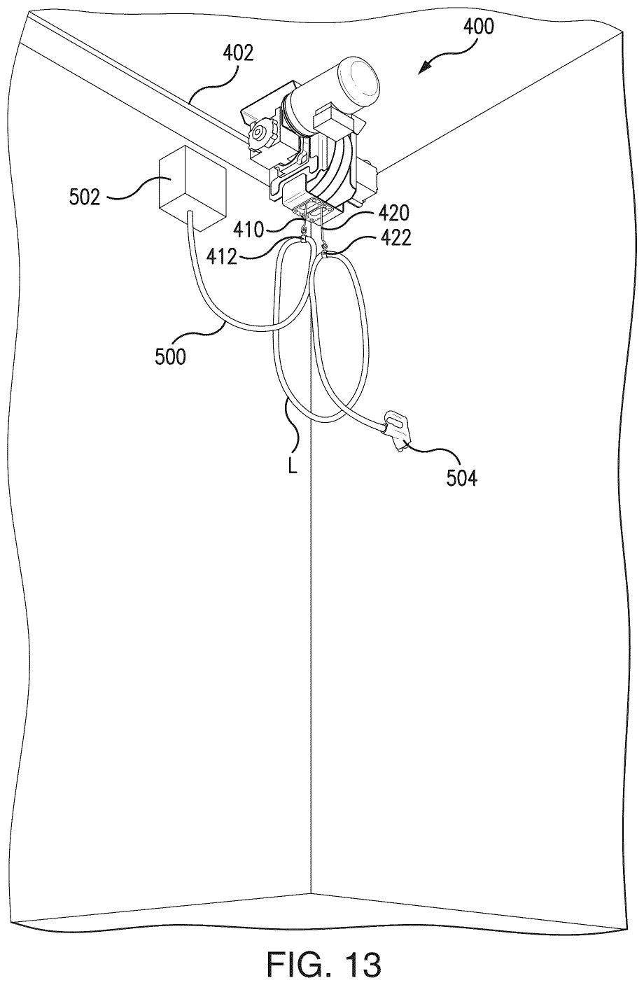

A first drum 140 and at least one second drum 150 are mounted on the shaft 130. In the exemplary embodiment, each of the first and second drums 140,150 have an outer diameter of approximately twelve (12) inches and an inner width of approximately one and a half (1.5) inches. Each of the first drum 140 and the second drum 150 is configured to receive a wire rope about its respective inner diameter. As shown in FIG. 5, the first drum 140 has an inner diameter D1 that is less than an inner diameter D2 of the second drum 150. In the exemplary embodiment, a ratio of D2 to D1 is approximately 2:1. For example, D2 may eight (8) inches and D1 may be four (4) inches. The motor 110 drives the shaft 130 (via the gear reducer 120) to reel and unreel the wire ropes. These dimensions and ratios are only exemplary and other ratios and dimensions may be used based on the needs of the particular application. As discussed below, and illustrated in FIGS. 13-16, the two wire ropes may be attached to different locations along a cable to selectively raise and lower the cable. Due to the different diameters D1,D2, the wire ropes reel and unreel at different rates thereby allowing for one portion of the cable to be lowered farther (and faster) than another portion.

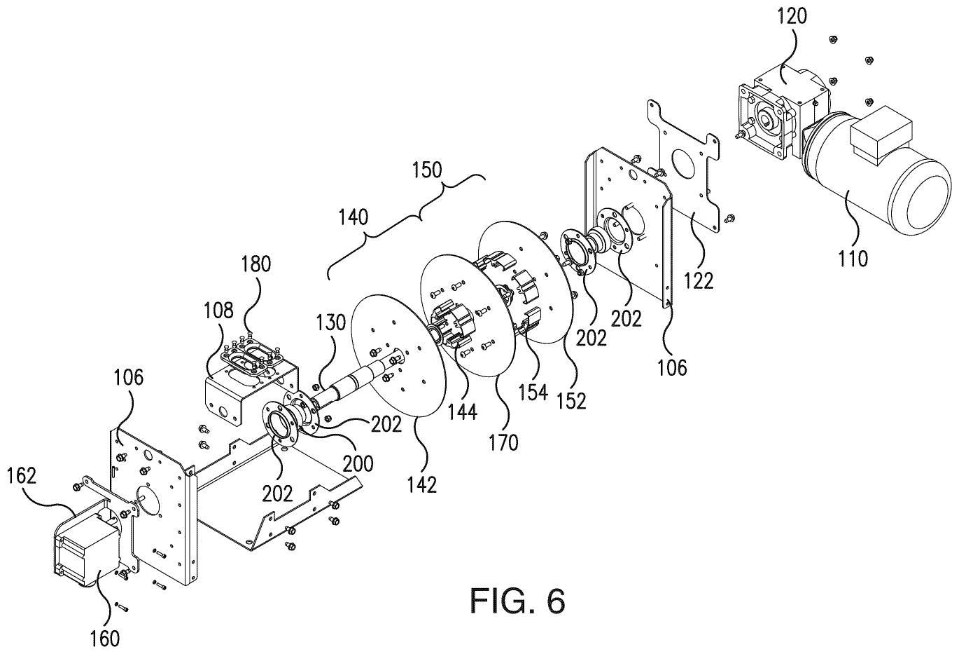

FIG. 6 is an exploded view of the reeling device 100. The housing 102 may include several housing components such as a base plate 104, two end plates 106, and a guide bracket 108. The components of the housing 102 may, for example, be made of sheet metal. The housing 102 may be secured with known fasteners. The base plate 104 includes a plurality of mounting holes for mounting the reeling device 100 to a surface (e.g., on a super structure).

In the exemplary embodiment, the guide bracket 108 includes a wire guide assembly 180 (e.g., as a single component or two separate wire guides) having openings positioned over each drum 140,150 for guiding the two wire ropes. The wire guide assembly 180 assists with keeping the wire ropes lined up with each drum 140,150. The housing 102 may further include an adapter plate 122 between the gear reducer 120 and one of the end plates 106.

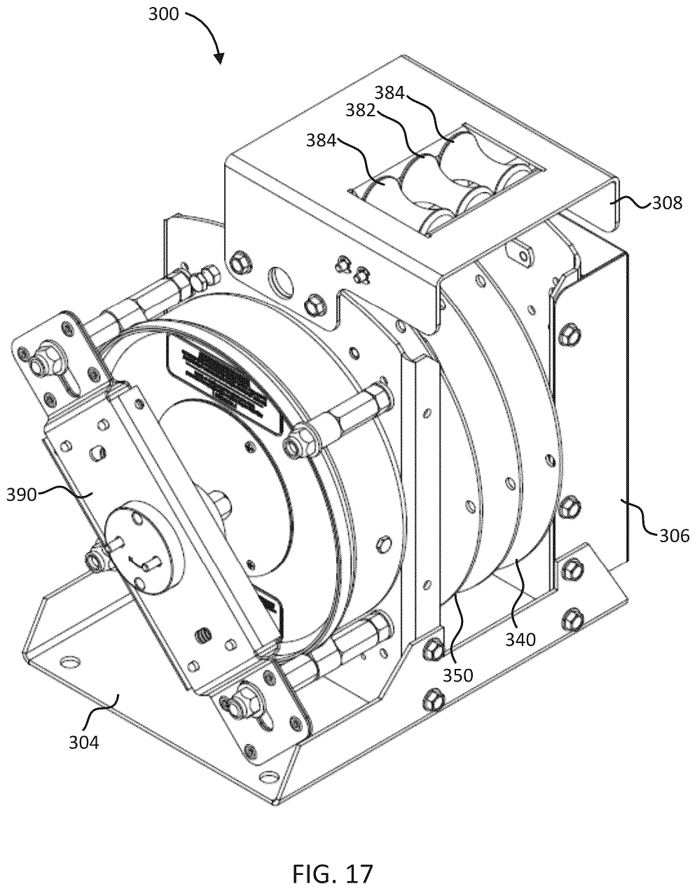

In one exemplary embodiment, the wire guide assembly 180 includes a plurality of rollers, e.g., as shown in FIG. 17 and described below.

As shown in FIG. 6, the first drum 140 is comprised of a spool disc 142, a spool disc 170, and a plurality of wrapper segments 144 defining the inner diameter D1. The second drum 150 is comprised of a spool disc 152, the spool disc 170, and a plurality of wrapper segments 154 defining the inner diameter D2. Though the first and second drums 140,150 share a common spool disc 170 in the exemplary embodiment, in other embodiments they each have a second and separate spool disc.

The reeling device 100 may further include two or more shaft bearings 200 with bearing housing components 202. In the exemplary embodiment, a rotary limit switch 160 is also mounted on a distal end of the shaft 130 using a mounting bracket 162. The rotary limit switch 160 limits the amount of travel, when both raising and lowering of the wire ropes. The limit switch 160 may monitor the reeling device 100's travel length, preventing accidental extension or retraction of the reel device 100 too far in either direction. The reeling device 100 may be configured to slowly come to a stop upon triggering either of the limit switch's top and bottom endpoints (e.g., set upon installation), only allowing operation in the opposite direction. Further, if the cable catches somewhere between the limit switch's endpoints, resistance may be detected and the motion of the reeling device 100 stopped, thereby avoiding or at least limiting damage to the reeling device 100 or surroundings.

The motor 110 may be controlled by a control panel equipped with a variable frequency drive (VFD) to allow the reeling device 100 to be adjusted to meet the customers varying applications. In some exemplary embodiments, the motor 110 of the reeling device 100 is operable remotely with a pushbutton pendant or Blue-Tooth/WiFi phone application to reel and unreel the wire ropes from the drums 140,150.

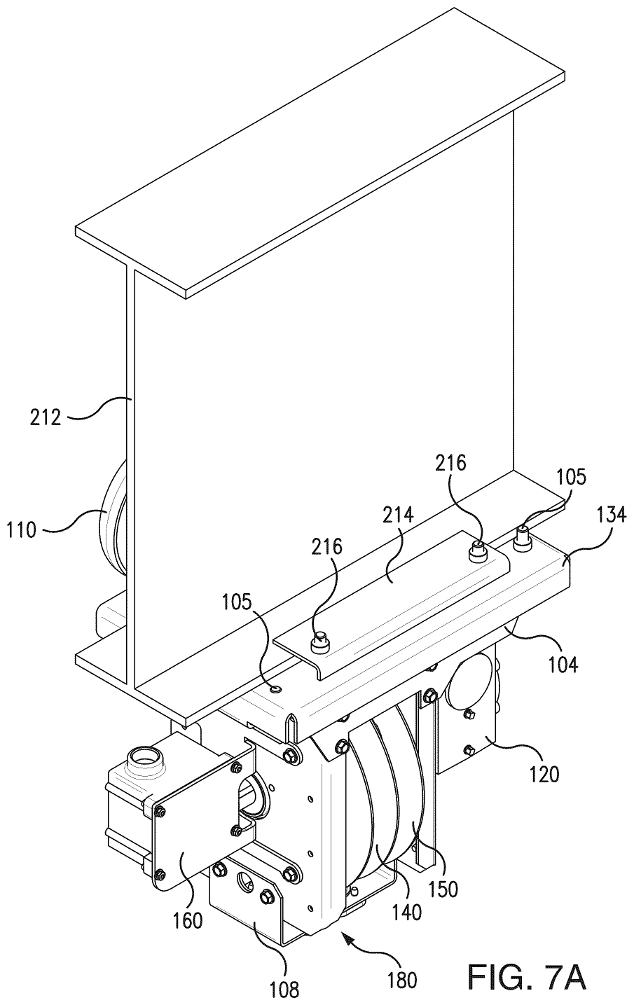

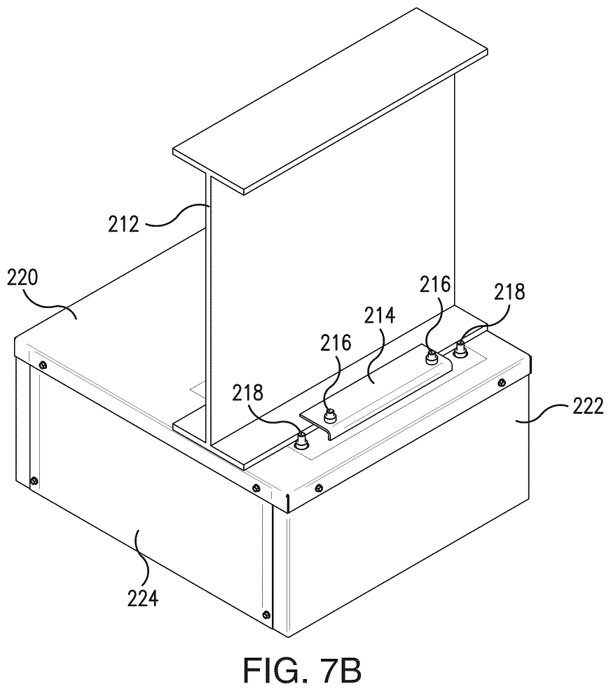

FIGS. 7A-7B show the reeling device 100 in a ceiling mounted configuration. When mounted on a ceiling, the reeling device 100 is arranged with the guide bracket 108 and the wire guide assembly 180 facing downward. The base plate 104 of the housing 102 is attached to a fixed feature of the ceiling, directly or via an intermediate plate 134. In the exemplary embodiment, the fixed feature is an I-beam 212. The intermediate plate 134 may be attached to the I-beam 212 with a single bracket 214, or two brackets 214 with one of either side of the I-beam 212, and fasteners 216.

As shown in FIG. 7B, a canopy may be provided at least partially covering the top and sides of the reeling device 100 in the ceiling mounted configuration. The canopy includes a top panel 220 attached to the base plate 104 and/or intermediate plate 134 of the reeling device 100 with a plurality of fasteners 218. The canopy further includes front and back panels 222 and two opposite side panels 224.

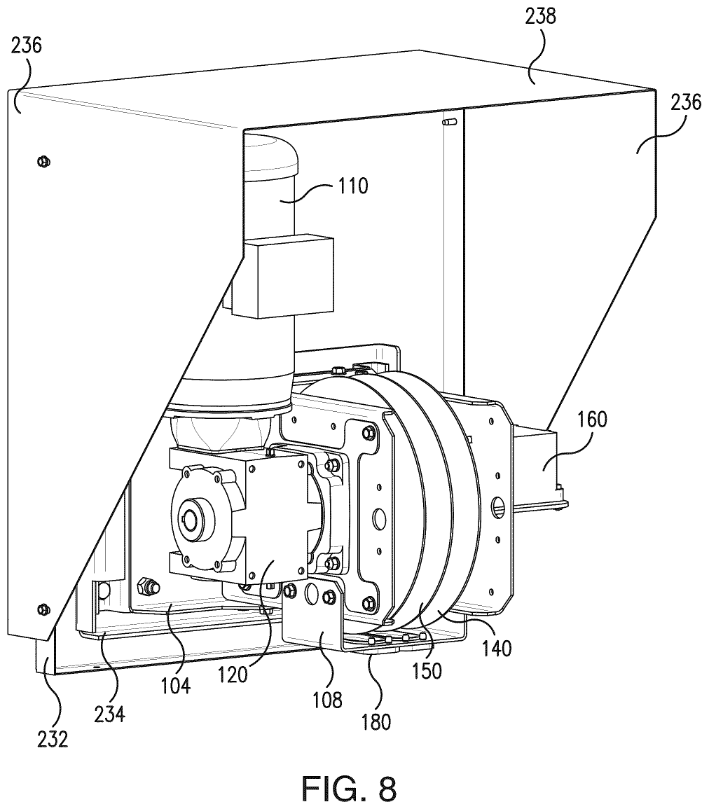

FIG. 8 shows the reeling device 100 in a wall mounted configuration. When mounted on a wall, the guide bracket 108 and the wire guide assembly 180 are repositioned ninety degrees so as to remain facing downward. As in the ceiling mounted configuration, a canopy also may be provided in the wall mounted configuration. The canopy includes a back panel 232 mounted to the base plate 104, directly or via an intermediate plate 234. The canopy further includes side panels 236 and a top panel 238. In the exemplary embodiment, the side panels 236 and the top panel 238 are one piece.

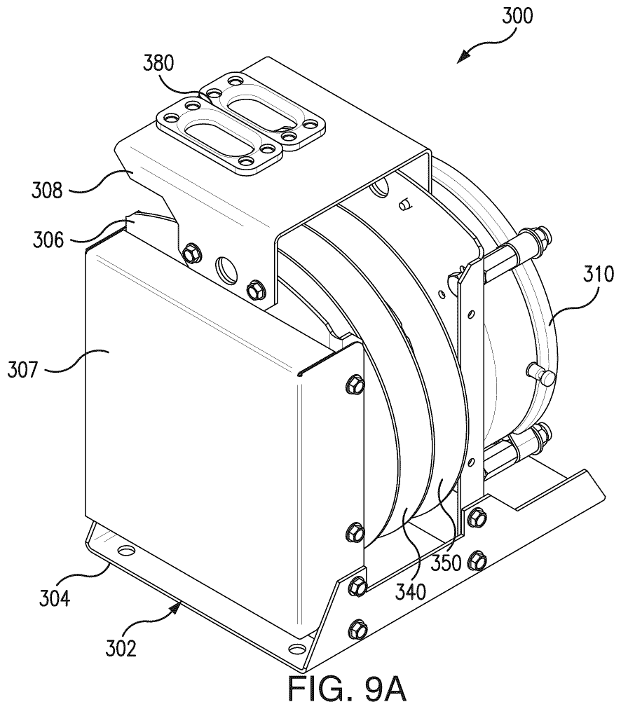

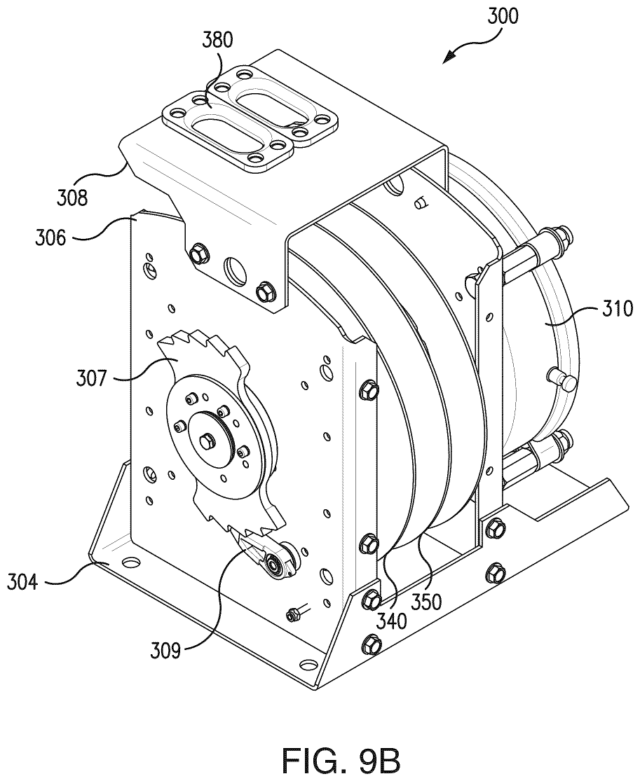

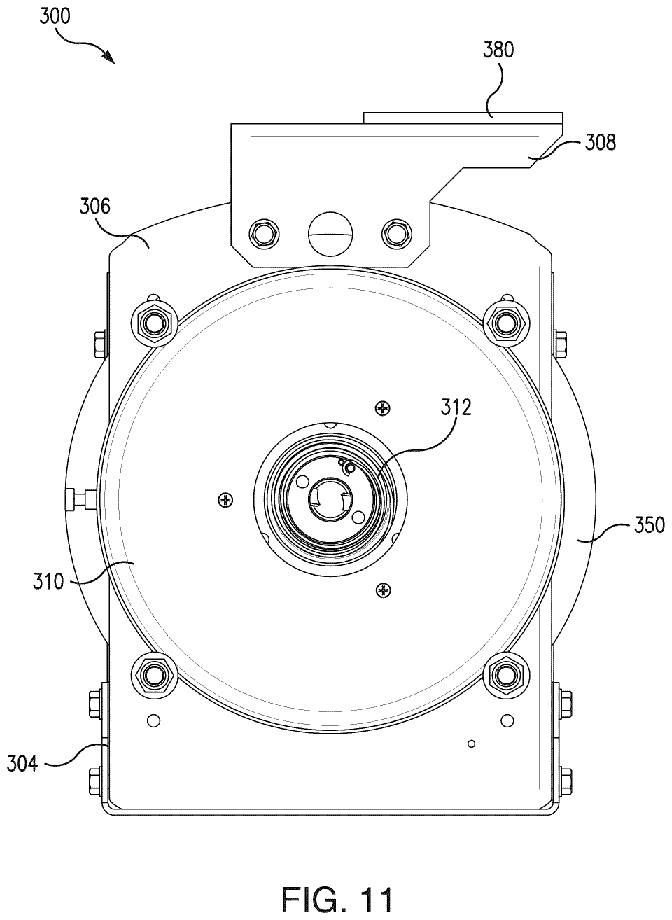

FIGS. 9A-12 show another reeling device 300 according to an exemplary embodiment of the present disclosure. The reeling device 300 shares most of the same mechanical components as the reeling device 100. The features and advantages of the reeling device 100 as discussed herein therefore apply to the reeling device 300. However, the reeling device 300 uses a spring motor as the retraction mechanism thereby eliminating the need for any electrical components.

The reeling device 300 includes a housing 302 (or frame) and a spring motor 310 secured to the housing 302. The spring motor 310 includes a spring 312 (e.g., a clock-type spring in a spring hub) which drives a shaft 330. For example, the spring 312 may be positioned in a spring hub of the spring motor 310 and extend at least partially around the shaft 330. The spring 312 may engage against grooves on the shaft 330 to impart a rotational force. Unlike the previous embodiment, the reeling device 300 may be operated by the user pulling on an attached cable to extend or retract the wire ropes wound about drums 340,350.

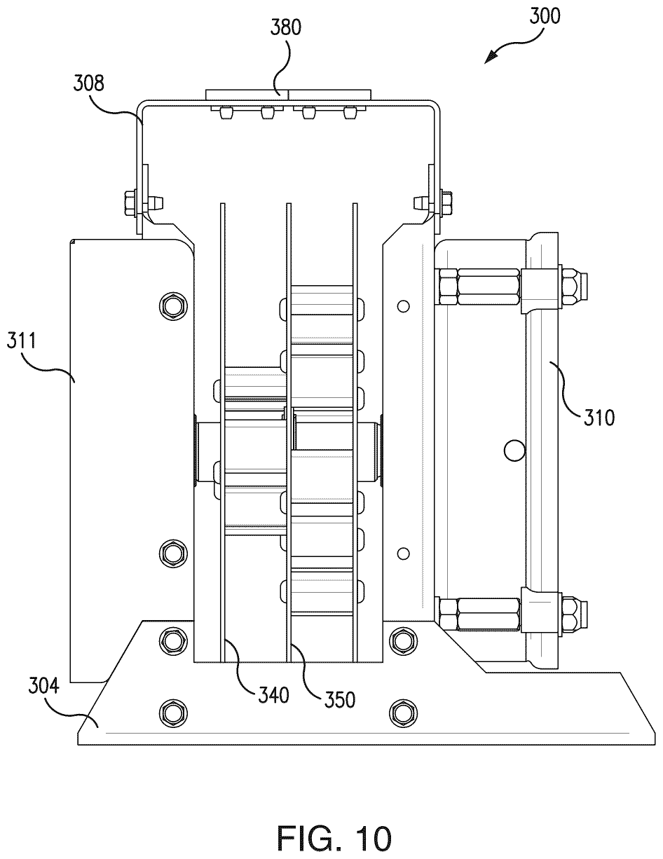

A first drum 340 and at least one second drum 350 are mounted on a shaft 330. Each of the first drum 340 and the second drum 350 is configured to receive a wire rope about its respective inner diameter. As shown in FIG. 10, the first drum 340 has an inner diameter that is less than an inner diameter of the second drum 150.

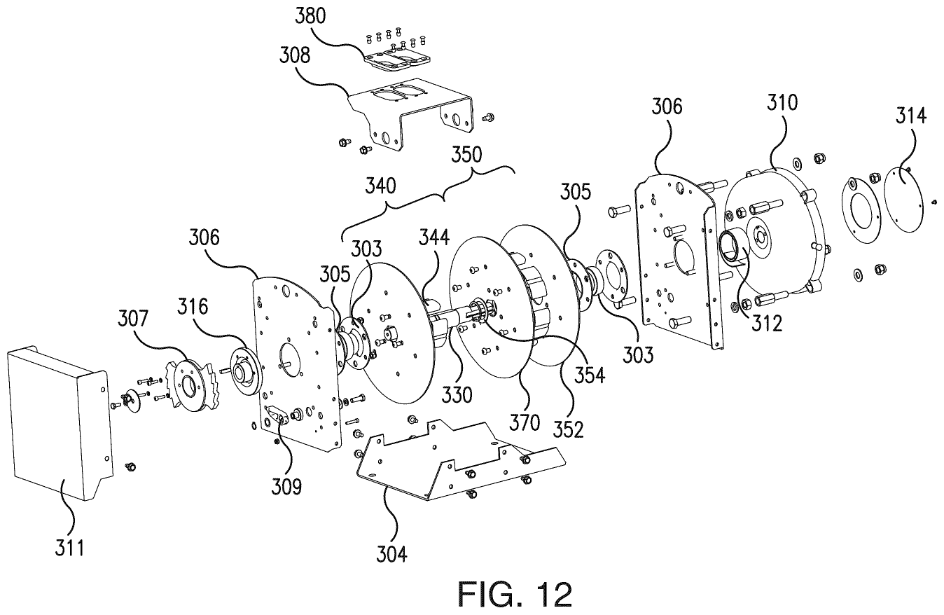

The spring motor 310 may include a locking mechanism to keep the drums 340,350 from rewinding after they are unreeled. As shown in FIGS. 9B and 12, the locking mechanism may be a rachet with a gear 307 that is attached to and rotates with the shaft 330, and a pawl 309 configured to engage with and lock the gear 307. The gear 307 may include two or more gear segments with radial gaps in between. In the exemplary embodiment, the gear 307 rotates clockwise as the drums 340,350 unreel (and release wire rope) and counterclockwise as the drums 340,350 reel in wire rope. As the drums 340,350 are unreeled, the gear 307 rolls over the pawl 309. At a desired position, a user may selectively release and/or pull on the cable or wire ropes to engage the pawl 309 between teeth on the gear 307. A cover 311 may be removably positioned over the locking mechanism.

As shown in FIGS. 10-12, the housing 302 may include several housing components such as a base plate 304, two end plates 306, and a guide bracket 308. The guide bracket 308 includes a wire guide assembly 380 (e.g., as a single component or two separate wire guides) having openings adjacent to each drum 340,350 for guiding the two wire ropes. The reeling device 300 may further include two or more shaft bearings 303 with bearing housing components 305. A cover 314 may be removably positioned over the spring 312.

In one exemplary embodiment, the wire guide assembly 380 includes a plurality of rollers. For example, as shown in FIG. 17, the wire guide assembly 380 may include a central roller 382 and two side rollers 384 positioned parallel to one another and defining the openings for the wire ropes therebetween. In some embodiments, the wire guide assembly 380 includes two additional rollers perpendicular to the central roller 382 and two side rollers 384 (e.g., under the guide bracket 308 between the rollers 382,384 and the drums 340,350) to keep the wire ropes centered in the wire guide assembly 380.

In some embodiments, at least one of the end plates 306 and at least one of the drums 340,350 have corresponding holes configured to a receive a spool lock (e.g., bolt or other fastener) to lock the position of the reeling device 300 for maintenance. In some embodiments, the reeling device 300 further includes a pre-tensioning assembly 390 connected to the spring motor 310 for use during commissioning and maintenance.

FIGS. 13-16 show a reeling device 400 according to an exemplary embodiment of the present disclosure in use. The reeling device 400 may, for example, be a motor driven reeling device 100 as shown in FIGS. 1-8 or a spring reel reeling device 300 as shown in FIGS. 9A-12. In the case of a motor driven reeling device, the device 400 may be controlled via a pendant (not shown) connected to the reeling device 400 via a wire 402, or in wireless communication with the reeling device 400.

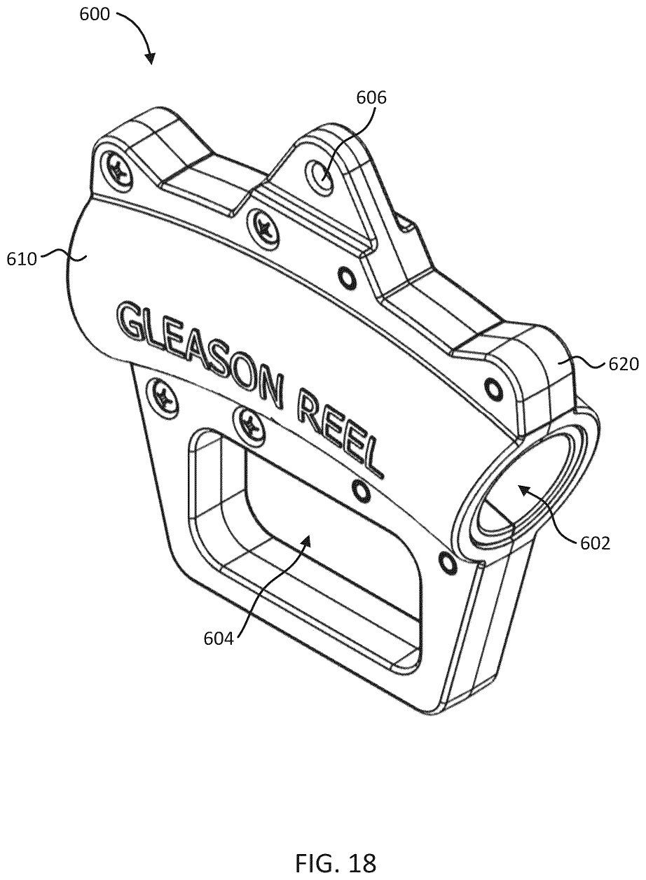

A first wire rope 410 is wound around the first drum and attached to an electrical cable 500 at a first position 412, e.g., using a wire rope clamp such as a saddle clamp. A second wire rope 420 is wound around the second drum and attached to the electrical cable 500 at a second position 422, e.g., using a wire rope clamp such as a saddle clamp. The saddle clamps may, for example, be of the type of saddle clamp shown in FIGS. 18-22E. The electrical cable 500 may be, for example, a charging cable for an electric vehicle. A proximal of end the cable 500 may be attached to an electrical power source 502 and a distal end may include a connector or adapter 504 for interfacing with an electric vehicle.

The second position 422 is distal to the first position 412. For example, the second position 422 may be spaced apart from the first position 412 along a length L of the electrical cable 500 by a distance of at least two (2) feet or at least five (5) feet. In the exemplary embodiment, the second position 422 is approximately eight (8) feet from the first position 412 along the length L of the electrical cable 500. Various length wire ropes may be used based on the particular application, such as 10-100 ft wire ropes.

In FIG. 13, the reeling device 400 is shown in a reeled configuration. Both wire ropes 410,420 are substantially retracted to secure the electrical cable 500 in an elevated position. The distal end of the first wire rope 410 attached at the first position 412 on the cable 500 and the distal end of the second wire rope 420 attached at the second position 422 on the cable 500 are approximately the same distance from the reeling device 400 and/or at the same or similar elevation.

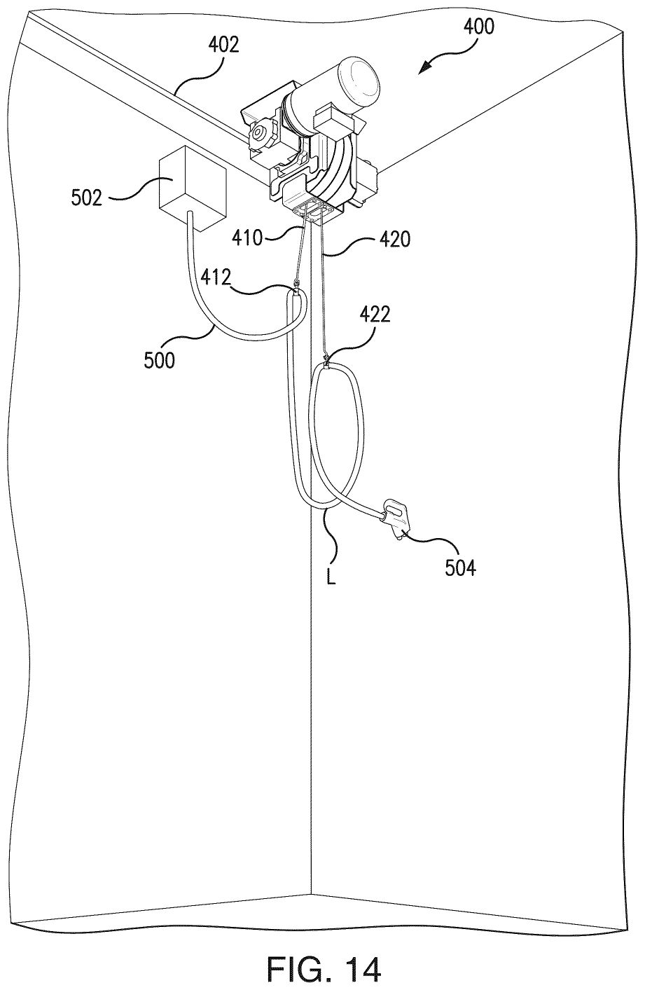

In FIG. 14, the reeling device 400 is in a first partially unreeled configuration. The reeling device 400 may be unreeled by operating a motor or by a user pulling on the cable when a spring reel is used. Due to the different diameters D1, D2, the wire ropes 410,420 are released at different rates of speed. Thus, the second wire rope 420 descends farther in a given time period resulting in the second position 422 of the cable 500 being lower (e.g., farther from the reeling device 400) than the first position 412 in the first partially unreeled position.

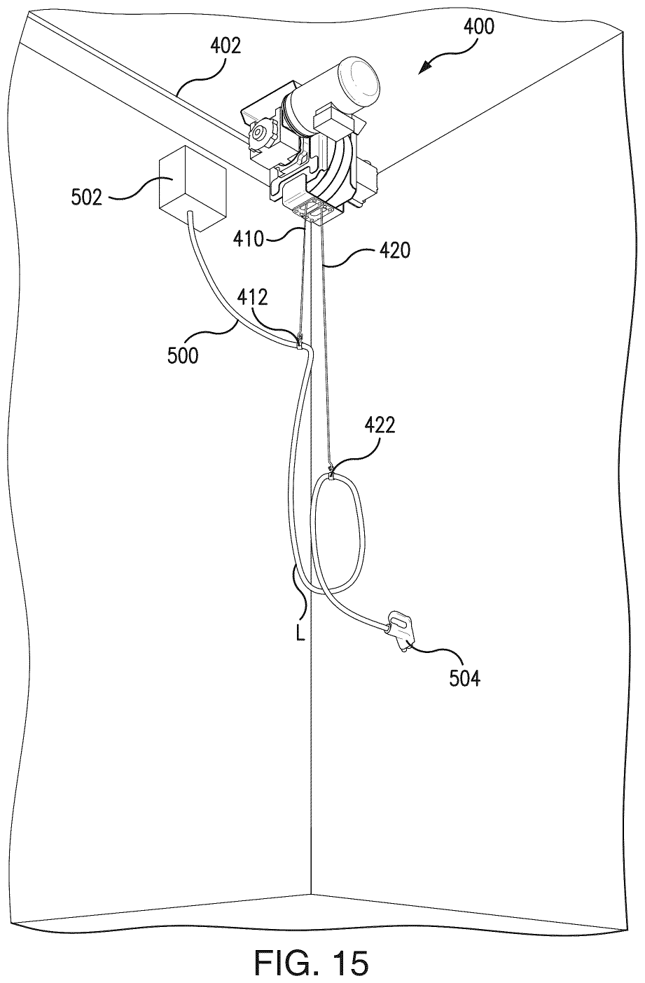

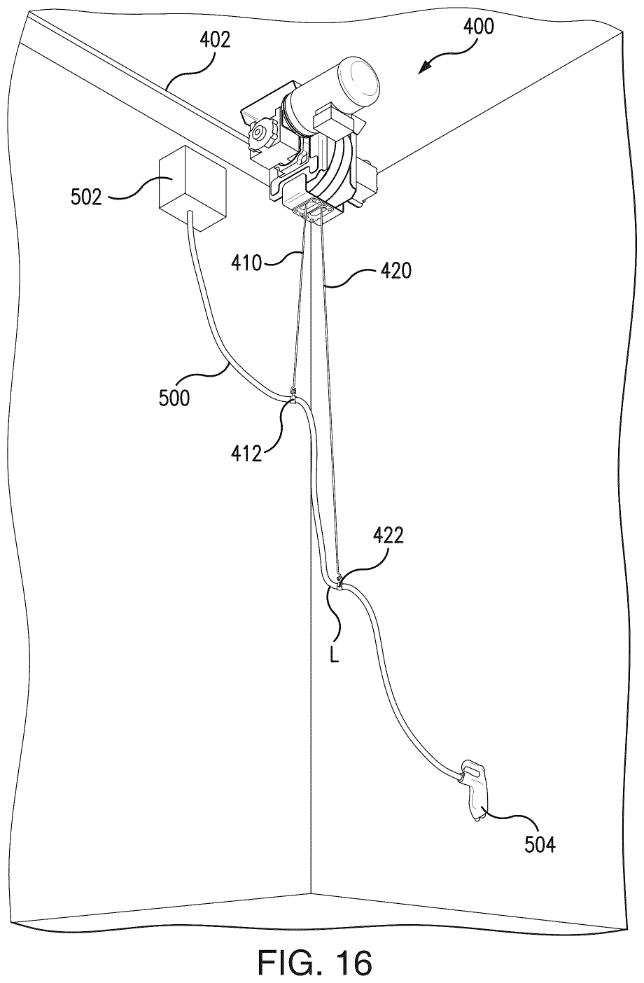

In FIG. 15, the reeling device 400 is in a second partially unreeled configuration in which the more distal portion of the electric cable 500 is even lower. In FIG. 16, the reeling device 400 is in a fully (or near fully) unreeled configuration. As illustrated, the electrical cable 500 is in an approximately vertical orientation when the reeling device 400 is unreeled due to the second wire rope 420 unreeling farther and faster than the first wire rope 410. When the reeling device 400 is a spring reel, the user may engage the locking mechanism in the unreeled configuration.

When used for electrical vehicle charging cables, the reeling devices disclosed herein allows for the charging cable to be retracted against the ceiling or wall of a structure and out of the way of passing vehicles and pedestrians, then selectively lowered to a vertical or near vertical position for charging. For example, a reeling device according to the present disclosure may be mounted next to a charging station for an electric vehicle and positioned above the EV traffic. The reeling device is configured to lift a charging cable vertically to an elevation above the vehicles. The two different wire ropes extending from the dual-drum reel are attached to two different lifting points (at two different elevations) on the electric charging cable. This allows the cable to be lifted from the vertical “charging” position to the stored position higher than the vehicles in the parking structure. The two different anchor points on the electric cable are lifted upwards at different rates and form two suspended loops.

FIGS. 18-22E illustrate a saddle clamp 600 for electric vehicle charging cables according to an exemplary embodiment of the present disclosure. The saddle clamp 600 may be employed in the reeling devices disclosed herein though its applications are not limited thereto.

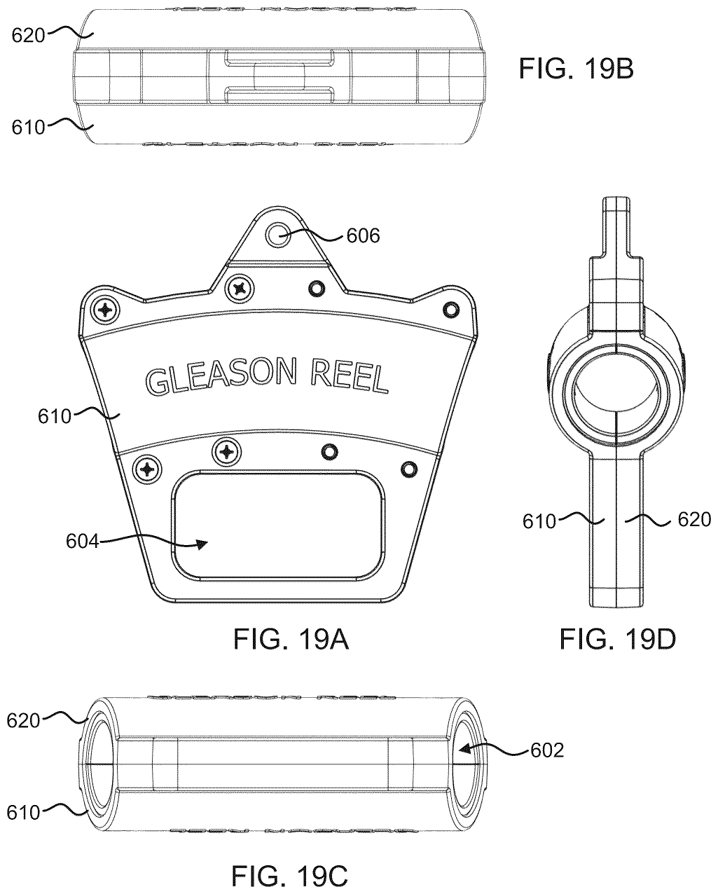

As shown in FIGS. 18-19D, the saddle clamp 600 includes a first housing part 610 and a second housing part 620 removably attached to one another with fasteners. In the exemplary embodiment, the housing parts 610,620 are substantially identical to one another and interchangeable. The housing parts 610,620 are comprised of a plastic material, such as nylon. In the exemplary embodiment, the housing parts 610,620 are comprised of a UV rated nylon 6 material. The saddle clamp 600 is designed to meet UL 2202 and be F1 rated.

Each of the housing parts 610,620 has an upper portion with a curved inner surface. The curved inner surfaces of the housing parts 610,620, when joined together, define a channel 602 for clamping around a cable such as the electrical cable 500 for charging an electric vehicle (e.g., at the positions 412,422 shown in FIGS. 13-16). In the exemplary embodiment, the channel 602 is a curved channel (i.e., at least partially angling downward on both open ends) with a circular cross-section along its length. The curved channel has a proper bend radius for easier installation and improved longevity of the cable.

Each of the housing parts 610,620 also has a lower portion with an opening 604 defining a handle for conveniently positioning of and/or pulling down on a cable clamped in the saddle clamp 600. The top of the saddle clamp 600 has a hole 606 for receiving or otherwise connecting to a wire, such as the wire ropes 410,420. Each of the housing parts 610,620 may have a separate corresponding hole 606a,606b.

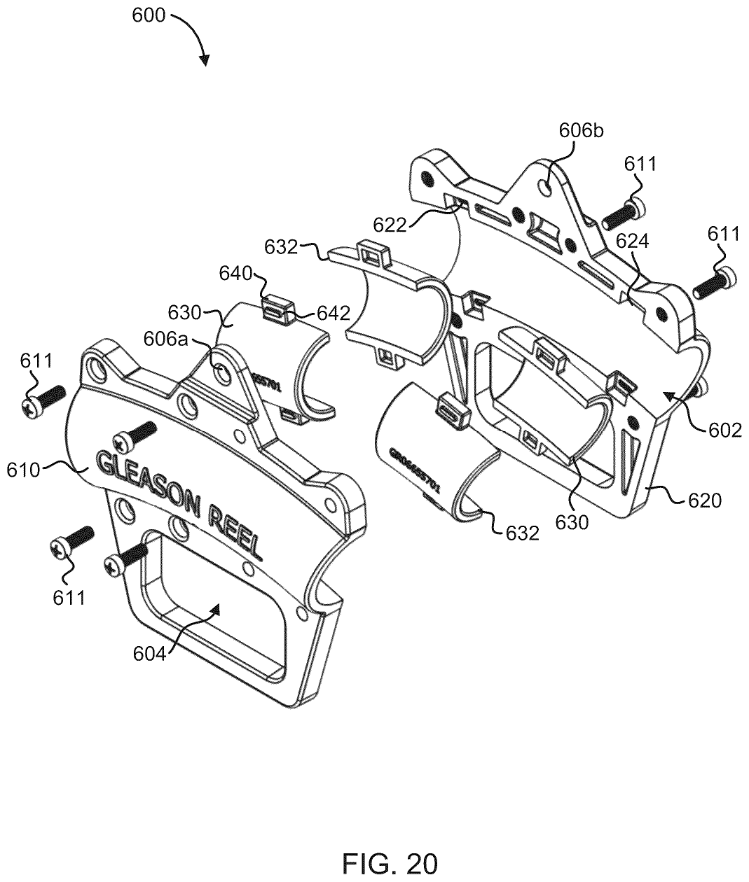

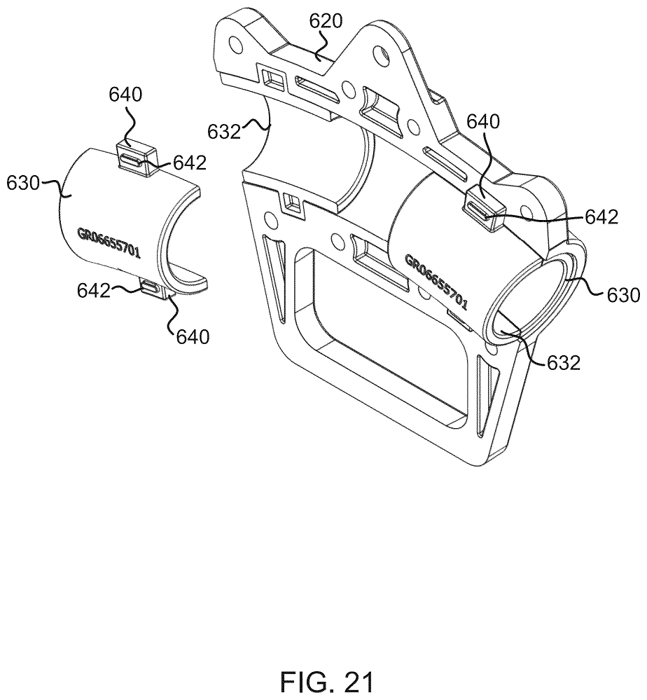

FIGS. 20-21 are exploded view of the saddle clamp 600. The housing parts 610,620 are removably attached to one another with fasteners, such as screws 611. In the exemplary embodiment, each of the housing parts 610,620 has a plurality of holes above and below the curve surface for receiving fasteners. The holes may have threaded inserts (e.g., metal inserts) for the fasteners.

The housing parts 610,620 receive and retain a plurality of inserts in the channel 602 comprised of insert halves or parts. The inserts may be comprised of a plastic material. In the exemplary embodiment, the first housing part 610 has two insert parts 630,632 (e.g., insert halves) which mate with corresponding insert parts 632,630 on the second housing part 620. Each of the insert parts 630,632 has vertically extending tabs 640 on the top and bottom with protrusions 642 on outwardly facing side surfaces. The tabs 640 engage within corresponding cavities 622,624 on the housing parts 610,620, which may have recesses for receiving the protrusions 642, when the saddle clamp 600 is assembled.

Inserts may be provided with a plurality of different inner diameters to accommodate different cable sizes. The saddle clamp 600 may be provided with one set of inserts for a particular cable size, or as a kit with a plurality of different inserts. In the exemplary embodiment, the saddle clamp 600 supports EV cables with an outer diameter of 1.25 in. to 1.88 in. by interchanging the inserts. However, additional insert sizes and/or different sized saddle clamps may be provided to accommodate any cable size.

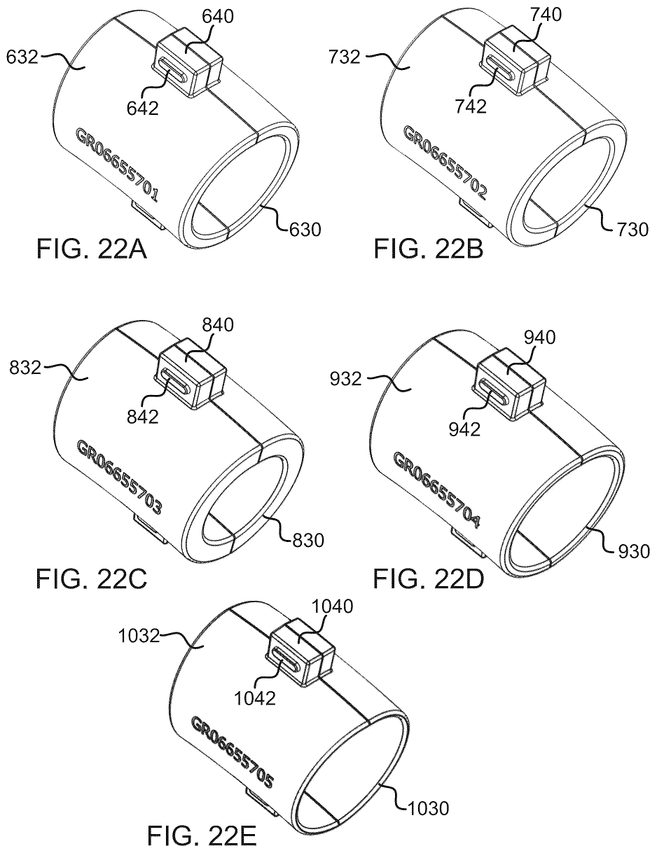

FIGS. 22A-22E show exemplary inserts for use in the saddle clamp 600. Each of the inserts has a different wall thickness and inner diameter but substantially the same outer profile, outer diameter, and tab size to be interchangeable in the saddle clamp 600. The insert shown in FIG. 22A with insert parts 630,632 and tabs 640 has an inner diameter sized to receive cables having outer diameters of 1.56-1.69 in. The insert shown in FIG. 22B with insert parts 730,732 and tabs 740 has an inner diameter sized to receive cables having outer diameters of 1.44-1.56 in. The insert shown in FIG. 22C with insert parts 830,832 and tabs 840 has an inner diameter sized to receive cables having outer diameters of 1.25-1.44 in. The insert shown in FIG. 22D with insert parts 930,932 and tabs 940 has an inner diameter sized to receive cables having outer diameters of 1.69-181 in. The insert shown in FIG. 22E with insert parts 1030,1032 and tabs 1040 has an inner diameter sized to receive cables having outer diameters of 1.81-1.88 in.

As shown throughout the drawings, like reference numerals designate like or corresponding parts. While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A reeling device, comprising:
a housing;
a retraction mechanism;
a shaft rotatable by the retraction mechanism;
a first drum coupled to the shaft with a first wire rope attached around the first drum; and
a second drum coupled to the shaft with a second wire rope is attached around the second drum, wherein the second drum has an inner diameter (D2) greater than an inner diameter (D1) the first drum,
wherein each of the first wire rope and the second wire rope has a saddle clamp attached at a distal end, the saddle clamp including a first housing part secured to a second housing part, a channel defined between the first housing part and the second housing part, and at least one insert removably positioned in the channel having an inner diameter sized to accommodate an electrical cable.

2. The reeling device of claim 1, wherein the diameter (D2) is at least twice the diameter (D1).

3. The reeling device of claim 1, further comprising:
an electrical cable;
wherein the first wire rope is secured to a first position on the electrical cable with one of the saddle clamps;
wherein the second wire rope is secured to a second position on the electrical cable with another one of the saddle clamps, the second position being distal to the first position.

4. The reeling device of claim 3, wherein the reeling device is operable between a reeled configuration in which the first and second positions of the electrical cable are at an approximately same distance from the reeling device and an unreeled configuration in which the second position of the electrical cable is further from the reeling device than the first position.

5. The reeling device of claim 1, wherein the retraction mechanism is a motor, the reeling device further comprising a gear reducer between the motor and a proximal end the shaft.

6. The reeling device of claim 5, further comprising a rotary limit switch on a distal end of the shaft.

7. The reeling device of claim 1, wherein the housing includes a base plate, first and second end plates attached to the base plate, wherein the first and second drums are positioned between the first and second end plates.

8. The reeling device of claim 7, further comprising a wire guide assembly attached between the first and second end plates including an opening to receive a first wire rope from the first drum and an opening to receive a second wire rope from the second drum.

9. The reeling device of claim 8, wherein the wire guide includes a plurality of rollers.

10. The reeling device of claim 1, wherein the retraction mechanism is a spring reel including a spring mounted about the shaft.

11. The reeling device of claim 1, further comprising a locking mechanism configured to selectively lock rotation of the first and second drums, wherein the locking mechanism includes a gear attached to the shaft and a pawl configured to engage with the gear.

12. The reeling device of claim 1, wherein the first housing part of the saddle clamp has a first upper portion with a first curved inner surface and the second housing part of the saddle clamp has a second upper portion with a second curved inner surface, the first curved inner surface and the second curved inner surface defining the channel.

13. The reeling device of claim 12, wherein the first housing part of the saddle clamp has a first lower portion with an opening and the second housing part of the saddle clamp has a second lower portion with an opening, the openings defining a handle of the saddle clamp.

14. The reeling device of claim 12, wherein the at least one insert includes a first insert part received in the first curved inner surface of the first housing part and a second insert part received in the second curved inner surface of the second housing part.

15. The reeling device of claim 1, wherein the at least one insert includes a plurality of inserts interchangeable in the channel, each having a different inner diameter to accommodate a different cable size.

16. A saddle clamp for a cable, comprising:
a first housing part having a first upper portion with a first curved inner surface;
a second housing part having a first upper portion with a second curved inner surface, the first housing part and the second housing part being removably attachable, wherein the first curved inner surface and the second curved inner surface define a channel through the saddle clamp;
at least one insert removably securable in the channel, the at least one insert having a first insert part received in the first curved inner surface of the first housing part and a second insert part received in the second curved inner surface of the second housing part.

17. The saddle clamp of claim 16, wherein the first housing part of the saddle clamp has a first lower portion with an opening and the second housing part of the saddle clamp has a second lower portion with an opening, the openings defining a handle of the saddle clamp.

18. The saddle clamp of claim 16, wherein each of the first insert part and the second insert part of the at least one insert has at least one radially extending tab, at least one radially extending tab engaging in the first housing part or the second housing part.

19. The saddle clamp of claim 18, wherein each of the first housing part and the second housing part includes a plurality of cavities adjacent to the first curved inner surface and the second curved inner surface, respectively, for receiving the tabs.

20. The saddle clamp of claim 16, wherein the at least one insert includes a plurality of inserts interchangeable in the channel, each having a different inner diameter to accommodate a different cable size.
